(19) United States
(12) Patent Application Publication
(10) Pub. No.: US 2025/0249670 A1
(43) Pub. Date: Aug. 7, 2025

(54) SYNTHETIC LEATHER

(71) Applicant: SAN FANG CHEMICAL INDUSTRY CO., LTD., KAOHSIUNG CITY (TW)

(72) Inventors: CHIH-YI LIN, KAOHSIUNG CITY (TW); KUO-KUANG CHENG, KAOHSIUNG CITY (TW); CHI-CHIN CHIANG, KAOHSIUNG CITY (TW); LI-YUAN CHEN, KAOHSIUNG CITY (TW); ZI HAO HSU, KAOHSIUNG CITY (TW)

(21) Appl. No.: 19/023,498

(22) Filed: Jan. 16, 2025

(30) Foreign Application Priority Data
Feb. 5, 2024 (TW) 113104524

(51) Int. Cl. B32B 27/12; B32B 3/30; B32B 5/02; B32B 7/022; B32B 27/08; B32B 27/18; B32B 27/32

(52) U.S. Cl. CPC B32B 27/12; B32B 3/30; B32B 5/022; B32B 5/024; B32B 7/022; B32B 27/08; B32B 27/18; B32B 27/32; B32B 2262/0253; B32B 2262/0284; B32B 2307/3065; B32B 2307/536; B32B 2307/554; B32B 2307/7376

(57) ABSTRACT

The present disclosure provides a synthetic leather including a base layer, a first polyolefin layer and a second polyolefin layer. The first polyolefin layer is disposed on the base layer, and a Shore A hardness thereof is about 40A to about 70A. The second polyolefin layer is disposed on the first polyolefin layer, and a Shore A hardness thereof is about 75 to about 98.

### BACKGROUND

### 1. Field of the Disclosure

The present disclosure relates to a synthetic leather, and more particularly to a synthetic leather for automotive interiors.

### 2. Description of the Related Art

Synthetic leather made of polyvinylchloride (PVC) is widely used in automotive interiors, which has the advantages of excellent flexibility and molding processability, and low production cost. However, the plasticizers contained in PVC are harmful to the human body and also the environment, making it desirable to develop a new synthetic leather to replace the aforementioned material.

### SUMMARY

The present invention provides a synthetic leather, comprising a base layer, a first polyolefin layer and a second polyolefin layer. The first polyolefin layer is disposed on the base layer, wherein a Shore A hardness of the first polyolefin layer is about 40 A to about 70 A. The second polyolefin layer is disposed on the first polyolefin layer, wherein a Shore A hardness of the second polyolefin layer is about 75 A to about 98 A.

In one embodiment, the base layer is a woven fabric or a non-woven fabric, and/or a material of the base layer is polypropylene or polyethylene terephthalate.

In one embodiment, a material of the first polyolefin layer and/or the second polyolefin layer is selected from the group consisting of thermoplastic polyolefin, thermoplastic vulcanizate, polyethylene, polypropylene and copolymers thereof.

In one embodiment, a melting point of the first polyolefin layer and/or the second polyolefin layer is about 130° C. to about 180° C.

In one embodiment, the first polyolefin layer further comprises a flame retardant.

In one embodiment, a thickness of the first polyolefin layer is about 0.1 mm to about 2 mm, and/or a thickness of the second polyolefin layer is about 0.01 mm to about 0.1 mm.

In one embodiment, a ratio of a thickness of the first polyolefin layer to a thickness of the second polyolefin layer is about 2:1 to about 10:1.

In one embodiment, the second polyolefin layer further comprises an abrasion-resistant additive.

In one embodiment, the synthetic leather further comprising a surface texture layer disposed on the second polyolefin layer.

In one embodiment, the second polyolefin layer has a textured surface.

### BRIEF DESCRIPTION OF THE DRAWINGS

FIG. 1 is a cross section of a synthetic leather 1 according to an embodiment of the present disclosure.

FIG. 2 is a cross section of a synthetic leather 1a according to an embodiment of the present disclosure.

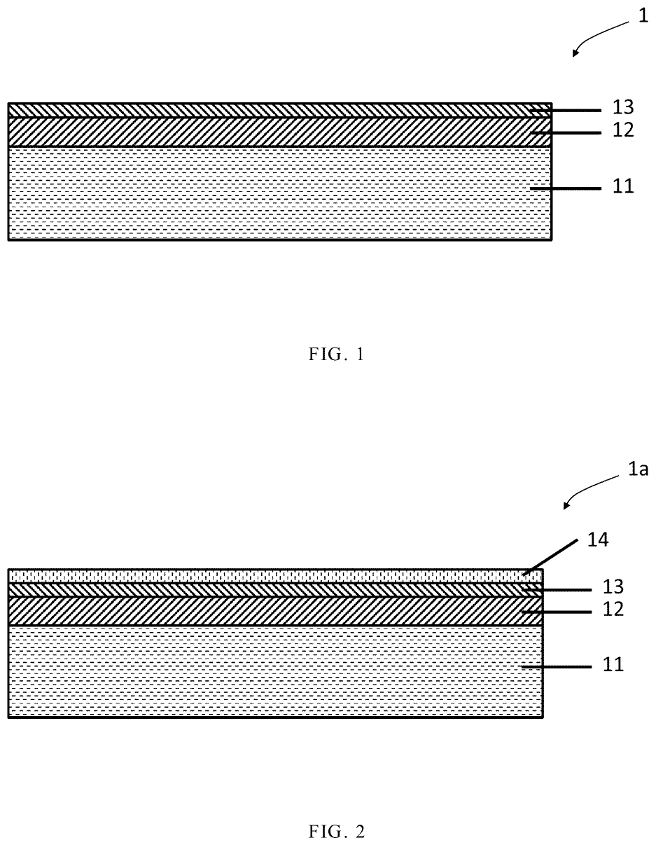

### DETAILED DESCRIPTION

The present invention provides a synthetic leather 1, comprising:
a base layer 11;
a first polyolefin layer 12 disposed on the base layer 11, wherein a Shore A hardness of the first polyolefin layer 12 is about 40 A to about 70 A; and
a second polyolefin layer 13 disposed on the first polyolefin layer 12, wherein a Shore A hardness of the second polyolefin layer 13 is about 75 A to about 98 A.

The base layer 11 may be a woven or non-woven fabric providing the resultant synthetic leather 1 with favorable planar structural strength and stretchability. For example, the “woven fabric” may be formed of one or more fibers interlaced in an organized manner, such as by weaving, knitting, crocheting, braiding, etc., and may be hand- or machine-made. The “nonwoven fabric” may be formed of multiple fibers by melt blowing, spin bonding or needle punching, none of which are limited in the present disclosure. In one embodiment, a material of the base layer 11 may be, for example, polypropylene or polyethylene terephthalate, but is not limited thereto.

A material of the first polyolefin layer 12 may be thermoplastic polyolefin (TPO), thermoplastic vulcanizate (TPV), polyethylene (PE), polypropylene (PP), one or more copolymers thereof, or a combination thereof. In some embodiments, a Shore A hardness of the first polyolefin layer 12 is between about 40 A to about 70 A, such as about 45 A, about 50 A, about 55 A or greater, and/or about 65 A, about 60 A, about 55 A or less. The Shore A hardness of the first polyolefin layer 12 may be controlled by adjusting the composition ratio thereof. In one embodiment, the first polyolefin layer 12 may include PP, TPO and TPV, at content of about 70% to about 100% of the total weight of the first polyolefin layer 12, such as about 75%, about 80%, about 85% or greater, and/or about 98%, about 96%, about 95%, about 90% or less.

In addition, the first polyolefin layer 12 may further include one or more flame retardants to prevent burning of the synthetic leather 1, or slow the spread of fire. For example, the retardant can constitute minerals (e.g., aluminum hydroxide, magnesium hydroxide or borates), organohalogen compounds, organophosphorus compounds, or carboxylic acid. In one embodiment, the flame retardant is organohalogen compounds, such as “ANTI-10”, purchased from Shanghai Research Institute of Chemical Industry (SRICI), but is not limited thereto. In one embodiment, the content of the flame retardant is about 1% to about 10% of the total weight of the first polyolefin layer 12, such as about 2%, about 3%, about 4%, about 5% or greater, and/or about 9%, about 8%, about 7%, about 6% or less.

In one embodiment, a thickness of the first polyolefin layer 12 is about 0.1 mm to about 2 mm, or about 0.23 mm to about 0.27 mm. A greater thickness of the first polyolefin layer 12 may provide the synthetic leather 1 with a rich hand feel, while an excess thickness may result in stiff hand feel and plastic look.

Material of the second polyolefin layer 13 can be TPO, TPV, PE, PP, one or more copolymers thereof, or a combination of the same. In some embodiments, a Shore A hardness of the second polyolefin layer 13 is between about 75 A to about 98 A, such as about 80 A, about 82 A, about 85 A or greater, and/or about 95 A, about 92 A, about 90 A or less. The Shore A hardness of the second polyolefin layer 13 may be controlled by adjusting the composition ratio thereof. In one embodiment, the second polyolefin layer 13 may include TPO or TPV having a Shore A hardness of about 80 A to about 98 A, and content thereof may be about 70% to about 100% of the total weight of the second polyolefin layer 13, such as about 75%, about 80%, about 85% or greater, and/or about 98%, about 96%, about 95%, about 90% or less.

In addition, the second polyolefin layer 13 may further include one or more abrasion-resistant additives, such as talcum (Mg₃Si₄O₁₀(OH)₂), silicone, calcium carbonate, magnesium sulfate, or a combination thereof. In one embodiment, the content of the abrasion-resistant additives may be about 1% to about 10% of the total weight of the second polyolefin layer 13, such as about 2%, such as about 3%, about 4%, about 5% or greater, and/or about 9%, about 8%, about 7%, about 6% or less.

The second polyolefin layer 13 may further include one or more UV absorbers, such as benzophenone, hindered amine, etc., to avoid degradation or deterioration of the synthetic leather 1 from sunlight when applied in automotive interiors. In one embodiment, the UV absorber is “Chimassorb 2020”, purchased from BASF Company, but is not limited thereto. In one embodiment, the content of the UV absorber may be about 0.2% to about 2% of the total weight of the second polyolefin layer 13, such as about 0.5%, such as about 0.8%, about 1% or greater, and/or about 1.7%, about 1.5%, about 1.2% or less.

In one embodiment, a thickness of the second polyolefin layer 13 is about 0.01 mm to about 0.1 mm, or about 0.04 mm to about 0.06 mm. A greater thickness of the second polyolefin layer 13 can provide the synthetic leather 1 with improved abrasion resistance, and contribute stiffness thereto.

In one embodiment, a melting point of the first polyolefin layer and/or the second polyolefin layer is about 130° C. to about 180° C., such as about 145° C., about 150° C., about 155° C., about 160° C. or greater, and/or about 175° C., about 170° C., about 165° C. or less. As such, the synthetic leather 1 can provide favorable heat resistance, suitable for automotive interiors.

In one embodiment, the synthetic leather 1 may be manufacture through the following steps:
(a) providing the base layer 11; and
(b) forming the first polyolefin layer 12 and the second polyolefin layer 13 on the base layer 11.

In one embodiment, the first polyolefin layer 12 and the second polyolefin .layer 13 may be formed concurrently, such as by co-extrusion through T-die, and laminated on the base layer 11. Alternatively, the first polyolefin layer 12 and the second polyolefin layer 13 may be formed separately as continuous films, and then sequentially disposed on and bonded to the base layer 11 through heat pressing. During lamination and heat pressing, the second polyolefin layer 13 may also be embossed to provide a textured surface similar to organic leather (genuine leather). In another embodiment (as shown in FIG. 2), the synthetic leather 1a further includes a surface texture layer 14 disposed on the second polyolefin layer 13. A material of the surface texture layer 14 may be polyurethane (PU), but is not limited thereto.

In the synthetic leather 1 of the present disclosure, the Shore A hardness of the first polyolefin layer 12 may be about 40 A to about 70 A, and the Shore A hardness of the second polyolefin layer 13 may be about 75 A to about 98 A. By using the first polyolefin layer 12 in combination with the second polyolefin layer 13, the first polyolefin layer 12 may provide the synthetic leather 1 with soft and rich hand feel, as well as favorable drapability, while the second polyolefin layer 13 may provide the synthetic leather 1 with favorable abrasion resistance. For example, drapability may be measured by TSL5100G 4.18 and/or GM Test Procedure GMW3390, at bending length less than 110 mm, preferably less than 80 mm, and more preferably less than 50 mm, to enhance soft hand feel of the synthetic leather 1.

In one embodiment, a thickness ratio of the first polyolefin layer 12 to the second polyolefin layer 13 is about 2:1 to about 10:1, such as about 3:1, about 4:1, about 5:1 or greater, and/or about 9:1, about 8:1, about 7:1, about 6:1 or less.

The following examples are given for illustrating the synthetic leather of the present disclosure and method for manufacturing the same, but are not intended to limit the scope of the present invention.

### Raw Material Description

Hard TPV: Shore A hardness 85 A, high strength and high abrasion resistance
Soft TPV: Shore A hardness 45 A
Hard TPO: Shore A hardness 85 A, high strength and high abrasion resistance
Soft TPO: Shore A hardness 60 A
Base layer fabric: PET knitted fabric
UV absorber: BASF Chimassorb 2020
Flame retardant: SRICI ANTI-10

### Example 1

98 parts by weight (wt %) of hard TPV and 2 parts by weight of UV absorber are mixed as the material of the second polyolefin layer, and 8 parts by weight of polypropylene, 32 parts by weight of soft TPO, 20 parts by weight of flame retardant and 40 parts by weight of soft TPV are used as the materials of the first polyolefin layer. The aforementioned materials are co-extruded through T-die to form the first polyolefin layer (with a thickness of approximately 0.23 mm to 0.27 mm) and the second polyolefin layer (with a thickness of approximately 0.04 mm to 0.06 mm), and are laminated on the fabric of the base layer (with a thickness of approximately 0.68 mm to 0.72 mm). Surface treatment is conducted concurrently to form a leather-like texture on a surface of the second polyolefin layer, and the surface of the second polyolefin layer is then coated with PU to form a surface texture layer (with a thickness of approximately 0.01 mm to 0.02 mm), thus forming the synthetic leather (with a thickness of approximately 0.9 mm) of Example 1. The evaluation results are as shown in Table 1.

### Examples 2 to 14 and Comparative Examples 1 to 4

Examples 2 to 14 and Comparative Examples 1 to 4 are manufactured through the same processes as the aforementioned Example 1, but with the raw materials listed in Tables 1 to 3. The evaluation results are as shown in Tables 1 to 3.

TABLE 1

| Example | | 1 | 2 | 3 | 4 | 5 | 6 | 7 |
|---|---|---|---|---|---|---|---|---|
| PU Coating | | Yes | Yes | Yes | Yes | Yes | No | No |
| Second | Hard TPV | 98 | 96 | 96 | 96 | 96 | 98 | 96 |
| Polyolefin | UV absorber | 2 | 2 | 2 | 2 | 2 | 2 | 2 |
| Layer | Talcum | | 2 | | | | | |
| (wt %) | Silicone | | | 2 | | | | 2 |
| | CaCO3 | | | | 2 | | | |
| | MgSO4 | | | | | 2 | | |
| First | PP | 8 | 8 | 8 | 8 | 8 | 8 | 8 |
| Polyolefin | Soft TPO | 32 | 32 | 32 | 32 | 32 | 32 | 32 |
| Layer | Flame Retardant | 20 | 20 | 20 | 20 | 20 | 20 | 20 |
| (wt %) | Soft TPV | 40 | 40 | 40 | 40 | 40 | 40 | 40 |

| Base Layer | Fabric | | | | | | |
|---|---|---|---|---|---|---|---|
| Abrasion Resistance (30000 | 5 | 5 | 4 | 4 | 4 | 4 | 5 |
| cycles) | | | | | | | |
| Heat Resistance | PASS | PASS | PASS | PASS | PASS | PASS | PASS |
| High Humidity-Heat Resistance | PASS | PASS | PASS | PASS | PASS | PASS | PASS |
| Drapability (mm) | 40 | 40 | 40 | 40 | 40 | 40 | 40 |

TABLE 2

| Example | | 8 | 9 | 10 | 11 | 12 | 13 | 14 |
|---|---|---|---|---|---|---|---|---|
| PU Coating | | Yes | Yes | Yes | Yes | Yes | No | No |
| Second | Hard TPO | 98 | 96 | 96 | 96 | 96 | 98 | 96 |
| Polyolefin | UV absorber | 2 | 2 | 2 | 2 | 2 | 2 | 2 |
| Layer | Talcum | | 2 | | | | | |
| (wt %) | Silicone | | | 2 | | | | 2 |
| | CaCO3 | | | | 2 | | | |
| | MgSO4 | | | | | 2 | | |
| First | PP | 8 | 8 | 8 | 8 | 8 | 8 | 8 |
| Polyolefin | Soft TPO | 32 | 32 | 32 | 32 | 32 | 32 | 32 |
| Layer | Flame Retardant | 20 | 20 | 20 | 20 | 20 | 20 | 20 |
| (wt %) | Soft TPV | 40 | 40 | 40 | 40 | 40 | 40 | 40 |

| Base Layer | Fabric | | | | | | |
|---|---|---|---|---|---|---|---|
| Abrasion Resistance (30000 | 5 | 5 | 4 | 4 | 4 | 4 | 5 |
| cycles) | | | | | | | |
| Heat Resistance | PASS | PASS | PASS | PASS | PASS | PASS | PASS |
| High Humidity-Heat Resistance | PASS | PASS | PASS | PASS | PASS | PASS | PASS |
| Drapability (mm) | 45 | 45 | 45 | 45 | 45 | 45 | 45 |

TABLE 3

| | | Comparative Example | | | |
|---|---|---|---|---|---|
| | | 1 | 2 | 3 | 4 |
| PU Coating | | Yes | Yes | No | No |
| Second Polyolefin | Soft TPV | 98 | | 96 | |
| Layer | Soft TPO | | 98 | | 96 |
| (wt %) | Silicone | | | 2 | 2 |
| | UV Absorber | 2 | 2 | 2 | 2 |
| | PP | 8 | 8 | 8 | 8 |
| | Soft TPO | 32 | 32 | 32 | 32 |
| | Flame | 20 | 20 | 20 | 20 |
| | Retardant | | | | |
| | Soft TPV | 40 | 40 | 40 | 40 |

| Base Layer | Fabric | | | |
|---|---|---|---|---|
| Abrasion Resistance | 2 | 2 | 2 | 2 |
| (30000 cycles) | | | | |
| Heat Resistance | PASS | PASS | PASS | PASS |
| High Humidity-Heat Resistance | PASS | PASS | PASS | PASS |
| Drapability (mm) | 35 | 35 | 35 | 35 |

### Evaluation

### Abrasion Resistance

To comply with the high abrasion resistance requirement of automotive interiors, the abrasion resistance of the synthetic leather is tested by using Gakushin Abrasion Tester (Honda Standard Test Method 11-2-2). Test piece size: 10 mm×50 mm (with 4 mm foam backing); loading weight: 4.9 N; cycle: 30000 cycles; abrading medium (the material to be abraded): cotton duck fabric with a size of 30 mm×250 mm. The abrasion resistance rating standard is as follows.
5: no visible scratches
4: slightly scratched (base layer not exposed)
3: obviously scratched (base layer slightly exposed)
2: base layer partially exposed
1: base layer exposed severely

### Heat Resistance

To comply with the heat resistance requirement of automotive interiors, a heat aging test is conducted on the synthetic leather, in which the sample is placed in an oven at 120° C. for 168 hours, and deemed to have passed if no obvious appearance changes, including discoloration (examined by spectrometer), sticky surface, cracks, pitting or embrittlement are observed.

### High Humidity-Heat Resistance

To comply with the heat resistance requirement of automotive interiors, a high-humidity heat aging test is conducted on the synthetic leather, in which the sample is placed in an oven at 90° C., 95% humidity for 840 hours, and deemed to have passed if no obvious appearance changes, including discoloration (examined by spectrometer), sticky surface, cracks, pitting or embrittlement are observed.

### Drapability

The tester is a platform having an incline with an inclination angle of 45 degrees. The material is cut to a size of 25 mm×200 mm to form a test piece, and the test piece is placed on the horizontal portion of the platform. A plate is disposed over the test piece and moved horizontally in a cantilever-like manner toward the incline at a rate of 10 mm/min to impel the test piece toward the incline, with the free end of the test piece bent downward. The movement is stopped when the free end of the test piece contacts the incline, and bending length is measured as the value of drapability.

While the present disclosure has been described and illustrated with reference to specific embodiments thereof, these descriptions and illustrations are not limiting. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. A synthetic leather, comprising:
a base layer;
a first polyolefin layer disposed on the base layer, wherein a Shore A hardness of the first polyolefin layer is about 40 A to about 70 A; and
a second polyolefin layer disposed on the first polyolefin layer, wherein a Shore A hardness of the second polyolefin layer is about 75 A to about 98 A.

2. The synthetic leather of claim 1, wherein the base layer is a woven fabric or a non-woven fabric.

3. The synthetic leather of claim 1, wherein a material of the base layer is polypropylene or polyethylene terephthalate.

4. The synthetic leather of claim 1, wherein a material of the first polyolefin layer is selected from the group consisting of thermoplastic polyolefin, thermoplastic vulcanizate, polyethylene, polypropylene and copolymers thereof.

5. The synthetic leather of claim 1, wherein a material of the second polyolefin layer is selected from the group consisting of thermoplastic polyolefin, thermoplastic vulcanizate, polyethylene, polypropylene and copolymers thereof.

6. The synthetic leather of claim 1, wherein a melting point of the first polyolefin layer is about 130° C. to about 180° C.

7. The synthetic leather of claim 1, wherein a melting point of the second polyolefin layer is about 130° C. to about 180° C.

8. The synthetic leather of claim 1, wherein the first polyolefin layer further comprises a flame retardant.

9. The synthetic leather of claim 8, wherein the flame retardant is selected from the group consisting of minerals, organohalogen compounds, organophosphorus compounds, or carboxylic acid.

10. The synthetic leather of claim 1, wherein a thickness of the first polyolefin layer is about 0.1 mm to about 2 mm.

11. The synthetic leather of claim 1, wherein a thickness of the second polyolefin layer is about 0.01 mm to about 0.1 mm.

12. The synthetic leather of claim 11, wherein the thickness of the second polyolefin layer is about 0.04 mm to about 0.06 mm.

13. The synthetic leather of claim 1, wherein a ratio of a thickness of the first polyolefin layer to a thickness of the second polyolefin layer is about 2:1 to about 10:1.

14. The synthetic leather of claim 1, wherein the second polyolefin layer further comprises an abrasion-resistant additive.

15. The synthetic leather of claim 1, further comprising a surface texture layer disposed on the second polyolefin layer.

16. The synthetic leather of claim 1, wherein the second polyolefin layer has a textured surface.
